(19) United States
(12) Patent Application Publication
(10) Pub. No.: US 2026/0186826 A1
(43) Pub. Date: Jul. 2, 2026

(54) Processor-Mediated Deterministic Execution Control and Bounded State Mutation Substrate

(71) Applicant: Andrew Louie Montilla Francisco, Saint Augustine, FL (US)

(72) Inventor: Andrew Louie Montilla Francisco, Saint Augustine, FL (US)

(21) Appl. No.: 19/542,902

(22) Filed: Feb. 18, 2026

(51) Int. Cl. G06F 9/48

(52) U.S. Cl. CPC G06F 9/485

(57) ABSTRACT

A processor-mediated deterministic execution control substrate maintains a fail-closed default state and conditionally permits state mutation within a bounded mutation epoch. Candidate state modifications are staged in a shadow region and atomically activated upon validation of a reference state representation. Replay mode suppresses application-layer invocation of live external retrieval and reconstructs state from enumerated schema-defined data. Optional tamper-evident mechanisms link state commitments across epochs. The invention improves mutation integrity and deterministic replay in distributed computing systems.

### FIELD OF THE INVENTION

The present invention relates to distributed computing systems and processor-mediated execution control.

More particularly, the invention relates to deterministic mutation gating, bounded mutation epochs, atomic activation of staged state, replay-verifiable reconstruction, and tamper-evident state continuity mechanisms.

### BACKGROUND OF THE INVENTION

Modern distributed computing systems and AI-integrated execution environments introduce nondeterministic behavior due to concurrent state mutation, floating-point non-associativity, approximate retrieval mechanisms, asynchronous processing, speculative execution, and schema evolution over time.

Such nondeterministic behavior impairs deterministic replay, complicates debugging and auditability, and undermines reliable reconstruction of prior system states.

Existing systems rely primarily on logging, access control, and external coordination mechanisms but do not enforce a fail-closed mutation boundary governing write access to an execution-context memory region.

In particular, prior approaches do not provide bounded mutation epochs combined with shadow staging, deterministic validation against a reference state representation, atomic activation of staged state, and replay-mode suppression of live nondeterministic inputs.

Accordingly, there exists a need for a deterministic execution control substrate that:
maintains a fail-closed default state;
permits mutation only within a bounded mutation epoch;
validates state transitions prior to activation;
atomically activates staged state modifications;
suppresses nondeterministic inputs during replay; and
optionally provides tamper-evident state continuity across mutation epochs.

### SUMMARY OF THE INVENTION

The invention provides a processor-mediated deterministic execution control substrate comprising:
An execution-context memory region maintained in a fail-closed state by default;
A mutation epoch triggered by a state-transition event;
Shadow-state staging of candidate modifications;
Atomic validation using a reference state hash comparison;
Conditional activation of staged state upon validation;
Replay-mode suppression of live external input;
Reconstruction from enumerated schema-defined data;
Optional tamper-evident linkage of state commitments across epochs.

The system improves deterministic execution reliability and mutation integrity in distributed computing environments.

### BRIEF DESCRIPTION OF THE DRAWINGS

FIG. 1 is a system architecture diagram illustrating a processor-mediated deterministic execution control substrate.

FIG. 2 is a mutation epoch lifecycle diagram illustrating fail-closed default state, shadow staging, validation, and atomic activation.

FIG. 3 is a shadow memory staging diagram illustrating candidate state modifications prior to activation.

FIG. 4 is a validation flow diagram illustrating comparison of reference state hash and observed state representation.

FIG. 5 is an atomic activation diagram illustrating compare-and-swap and transactional commit embodiments.

FIG. 6 is a replay-mode suppression diagram illustrating suppression of application-layer invocation of external retrieval during reconstruction.

FIG. 7 is an enumerated schema reconstruction diagram illustrating deterministic replay from schema-defined stored data.

FIG. 8 is a state continuity diagram illustrating hash chaining and Merkle tree embodiments.

FIG. 9 is a deployment embodiment diagram illustrating managed runtime, clustered execution, and containerized environments.

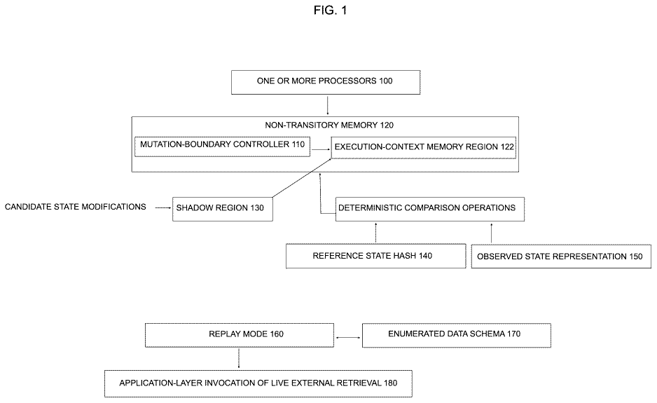

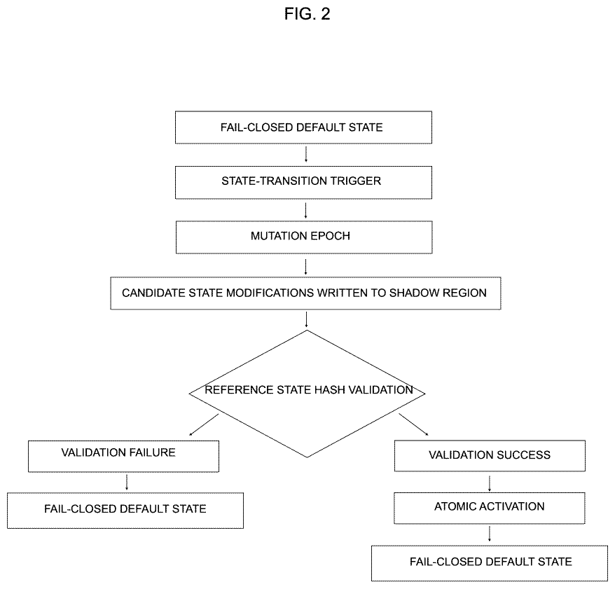

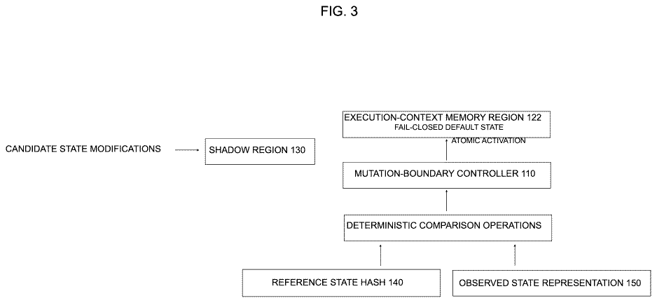

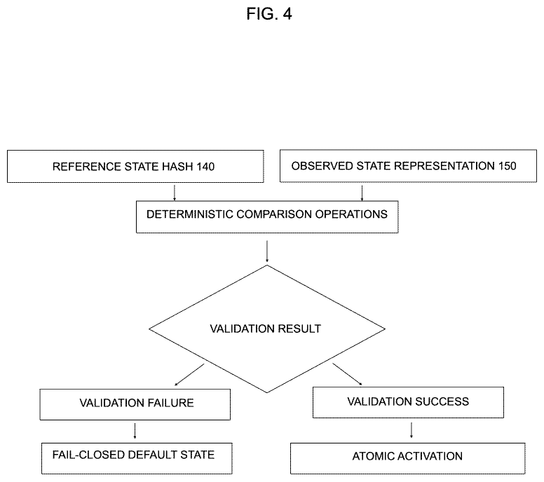

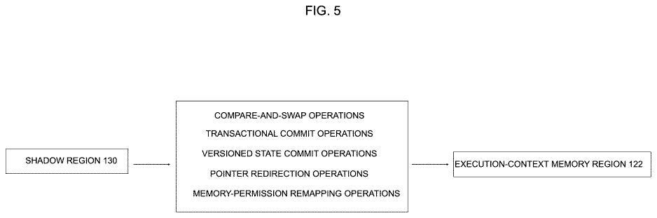

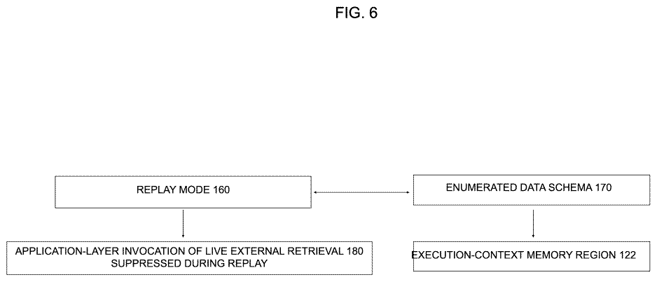

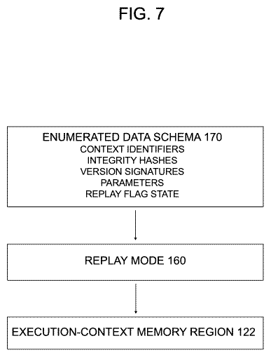

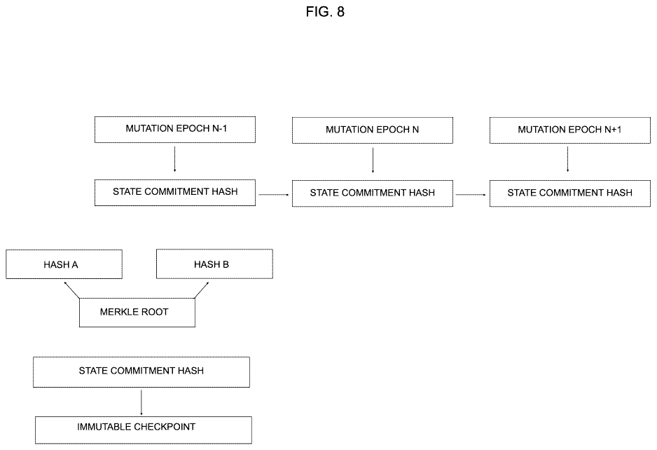

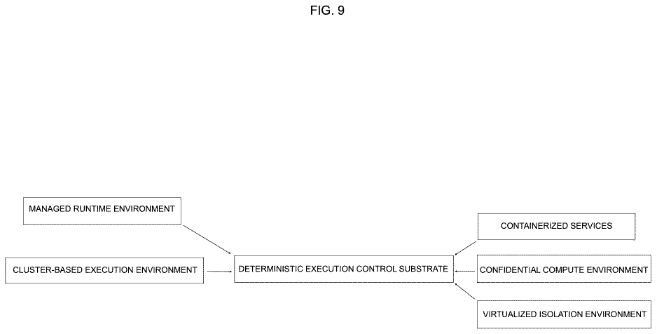

The following detailed description provides exemplary embodiments of the processor-mediated deterministic execution control substrate as illustrated in FIGS. 1-9.

### DETAILED DESCRIPTION OF THE INVENTION

### Definitions

Execution-Context Memory Region: A logical memory region representing governed state subject to mutation control.

Fail-Closed Default: A state in which write-permission to the execution-context memory region is inhibited unless explicitly enabled within a mutation epoch.

Mutation Epoch: A bounded interval during which candidate state changes may be staged and conditionally activated.

Shadow Region: A non-active region in which candidate state modifications are staged prior to activation.

Reference State Hash: A deterministic representation of the current authoritative state used for validation.

Replay Mode: An execution mode in which live external retrieval and nondeterministic inputs are suppressed and state is reconstructed exclusively from enumerated schema-defined sources.

1. A computing system comprising:
one or more processors;
a non-transitory memory comprising an execution-context memory region;
a mutation-boundary controller stored in memory and executable by the one or more processors;
wherein execution of the mutation-boundary controller by the one or more processors causes the system to:
maintain the execution-context memory region in a default write-inhibited state enforced via processor-executed mutation boundary control applied to the execution-context memory region;
detect, via processor-executed instructions, a state-transition trigger;
initiate a bounded mutation epoch in response to the detected state-transition trigger;
stage candidate state modifications in a shadow memory region distinct from the execution-context memory region while preventing write access to the execution-context memory region;
validate a reference state hash against an observed state representation using deterministic comparison operations executed by the one or more processors;
upon successful validation, atomically activate the staged modifications using at least one of:
compare-and-swap operations;
transactional commit operations;
versioned state commit operations;
pointer redirection operations; or memory-permission remapping operations executed at the mutation boundary;
upon completion or failure of the mutation epoch, revert the execution-context memory region to the default write-inhibited state; and
during a replay mode:
suppress application-layer invocation of live external retrieval;
gate execution paths associated with nondeterministic input sources; and
reconstruct system state exclusively from enumerated schema-defined stored data.

2. A method of deterministic state mutation control comprising:
maintaining a governed memory region in a write-inhibited default state via processor-enforced mutation boundary control;
detecting a state-transition trigger;
initiating a mutation epoch;
staging candidate modifications in a shadow region;
validating a reference state hash against an observed state representation;
atomically activating the staged modifications upon validation;
reverting to a write-inhibited state upon completion or failure; and
suppressing application-layer invocation of live external retrieval during replay reconstruction.

3. A non-transitory computer-readable medium storing instructions that, when executed by one or more processors, cause the processors to perform the method of claim 2.

4. The system of claim 1, wherein validation comprises a compare-and-swap operation.

5. The system of claim 1, wherein validation comprises a transactional commit embodiment.

6. The system of claim 1, wherein deterministic normalization includes lexicographic tie-breaking.

7. The system of claim 1, wherein deterministic normalization includes fixed-point arithmetic.

8. The system of claim 1, wherein replay mode suppresses application-layer network invocation.

9. The system of claim 1, wherein replay reconstruction uses a versioned enumerated schema.

10. The system of claim 1, further comprising a tamper-evident state continuity mechanism.

11. The system of claim 10, wherein the tamper-evident mechanism comprises hash chaining.

12. The system of claim 10, wherein the tamper-evident mechanism comprises Merkle tree construction.

13. The system of claim 1, wherein activation is performed via pointer redirection.

14. The system of claim 1, wherein activation is performed via processor-enforced mutation boundary remapping.

15. The system of claim 1, wherein the mutation epoch is bounded by a finite state machine.

16. The system of claim 1, wherein idempotent command identifiers prevent duplicate mutation.

17. The system of claim 1, wherein validation requires matching of expected and observed state hashes.

18. The system of claim 1, further comprising schema evolution compatibility enforcement.

19. The system of claim 1, wherein replay mode is globally enforced across services.

20. The system of claim 1, wherein export or external transmission of state is treated as a gated state-transition event requiring mutation boundary validation.
